(19) United States
(12) Patent Application Publication
(10) Pub. No.: US 2005/0097767 A1
(43) Pub. Date: May 12, 2005

(54) Wiping device

(76) Inventors: Lloyd Junior Brasch, Red Bluff, CA (US); Jeremy Brasch, Red Bluff, CA (US)

Correspondence Address: Ken Campbell, P.O. Box 551, Fair Oaks, CA, 95628, US

(21) Appl. No.: 10/705,425

(22) Filed: Nov. 10, 2003

(51) Int. Cl. G01F 23/04

(52) U.S. Cl. 33/725

(57) ABSTRACT

This invention is a cleaning device that is used in its preferred embodiment to wipe fluid from a dipstick. The invention comprises an opposing pair of matching features that are mounted to the interior of a rigid, folding enclosure. When fastened around a dipstick, the matching features in the preferred embodiment wipe the dipstick free of fluid.

### BACKGROUND

This invention relates to wiping devices for long, slender objects, such as motor oil dipsticks.

In checking the level and condition of the fluid in a motor crankcase, transmission, or power-assist pump, a common way is to observe the fluid level on the appropriate dipstick. In doing so, one usually pulls the dipstick out to wipe it clean, re-inserts it, then pulls it out again to check the actual fluid level. To wipe the dipstick clean, one normally uses an absorbent material that is free of dirt and debris. Many people use a paper towel or cloth rag. But, these items often allow oil to soak through to the hands, usually requiring additional cleanup. This also creates unnecessary waste.

The device of this invention is used to conveniently wipe clean a fluid dipstick, while preventing the fluid itself from soaking into the hands. This allows the user to check fluid levels often, without ever having to clean-up afterward.

### SUMMARY

In accordance with this invention, a device comprises a base and a cap that are hinged along one side, a latching means on the opposite side. The invention also comprises an opposing pair of wiping features, as one is secured to the interior of the base and the other is secured to the interior of the cap.

The preferred embodiment of this invention is used to wipe fluids from typical dipsticks. In general, however, the function of this invention may also include the act of applying a thin layer of fluid to appropriate objects, for the purpose of lubricating, painting, etc.

The function of this invention may also incorporate a variety of said wiping features in which, for example, a flow of a cleansing liquid, such as water, is instituted with the housing to facilitate thorough cleaning.

### REFERENCE TO DRAWINGS

### Drawing Figures

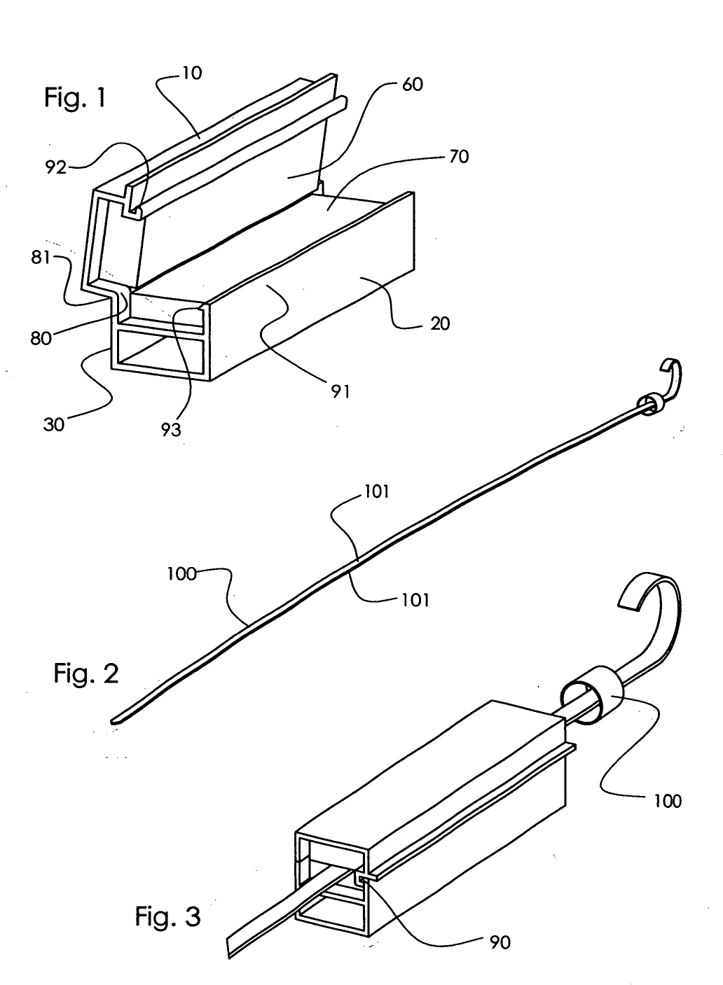

FIG. 1 shows the preferred embodiment of the invention in the open position, in perspective.

FIG. 2 shows a typical dipstick, in perspective

FIG. 3 shows the preferred embodiment of the invention containing a dipstick in the closed position, in perspective.

Reference Numerals in Drawings

10 Cap
20 Base
30 Housing
40 Interior Cap Surface
50 Interior Base Surface
60 Cap Pad
70 Base Pad
80 Hinging Means
81 Hinge Side
90 Latching Means
91 Latch Side
92 Catch
93 Strike
100 Fluid Dipstick
101 Exposed Surface of Dipstick

### DETAILED DESCRIPTION

A preferred embodiment of the invention is shown in FIG. 1. This embodiment comprises a uniform cross section, consisting of an extruded shape. This embodiment also comprises two pads of soft, absorbent material that are fastened into the extruded shape. The extruded shape forms a cap 10 and a base 20. Together the cap and the base are referred to as a housing 30. The cap can be opened and closed, while remaining attached to the base by a hinging means 80, along a hinge side 81. Once closed, the cap can be secured to the base using an appropriate latching means on a latch side 91, which is opposite the hinge side. The two pads are referred to as a cap pad 60 and a base pad 70. When the invention is in the closed position, the two pads contact each other across a single plane. When the device is in the closed position, it can perform its intended function.

In the preferred embodiment, the hinging means comprises a contiguous segment of extruded material, which is adjacent to both the cap and the base along the hinge side. The extruded material is plastic, but can also be some other material that is suitable for allowing the invention to open and close repeatedly, while said material remains pliable.

In the preferred embodiment, the latching means comprises both a catch 92 featured on the cap, and a mating strike 93 featured on the base. Both of which are contiguous portions of the extruded shape.

In the preferred embodiment, the pads 60 & 70 are made of felt material. Using an appropriate fastening means, such as ordinary glue, they are affixed directly to interior surfaces of the invention. They are positioned in such a way that, when the invention is in its closed position, the pads contact each other squarely and uniformly. The housing of the invention protects the pads from contamination, and from contacting other objects.

FIG. 2 shows a typical fluid dipstick 100, found in many automobiles. When used with the intended function of the preferred embodiment, the invention will wipe fluid from a typical dipstick. In use, the invention is opened to accept the dipstick. Once the dipstick is removed from its designated operating location, the invention is placed around the exposed portion of the dipstick near its handle. The invention is positioned in such a way that, when the invention is in its closed position, the felt pads will contact both exposed surfaces 101 of the dipstick.

In FIG. 3, the invention is shown in the closed position, containing the dipstick 100. Once the invention is closed onto the the exposed surfaces and held shut by the latching means 90, the dipstick can be pulled through the invention to be wiped free of fluid. As the dipstick is pulled through the invention, the fluid on the dipstick is absorbed by the pads of felt, and kept from soaking the hands of the user. When the stick is removed completely from the invention, it is replaced in its designated location to check the fluid.

1. A wiping device comprising a base and a cap that are attached to each other by a hinging means that exists along a hinge side of said device, a latching means that exists on a latch side located opposite from the hinge side of the device, and a pair of wiping features that are each secured to the interior of said device.

2. The device in claim 1 wherein said latching means comprises a catch, in such a way that said catch and said cap exist together as a continuous piece of material.

3. The device in claim 1 wherein said latching means comprises a catch, in such a way that said catch and said base exist together as a continuous piece of material.

4. The device in claim 1 wherein said latching means comprises a strike, in such a way that said strike and said cap exist together as a continuous piece of material.

5. The device in claim 1 wherein said latching means comprises a strike, in such a way that said strike and said base exist together as a continuous piece of material.

6. The device in claim 1 wherein said latching means comprises a catch and a strike, in such a way that said strike and said base exist together as a continuous piece of material, and in such a way that said catch and said cap exist together as a continuous piece of material.

7. The device in claim 1 wherein said latching means comprises a catch and a strike, in such a way that said catch and said base exist together as a continuous piece of material, and in such a way that said strike and said cap exist together as a continuous piece of material.

8. The device in claim 1 wherein said hinging means is joined to said base and to said cap, in such a way that said hinging means, said base, and said cap exist together as a continuous piece of material, which is refered to as a housing.

9. The device in claim 8 wherein said latching means comprises a catch, in such a way that said catch and said housing exist together as a continuous piece of material.

10. The device in claim 8 wherein said latching means comprises a strike, in such a way that said stirke and said housing exist together as a continuous piece of material.

11. The device in claim 8 wherein said latching means comprises a catch and a strike, in such a way that said catch, said strike, and said housing exist together as a continuous piece of material.
